(19) United States
(12) Patent Application Publication
(10) Pub. No.: US 2020/0324364 A1
(43) Pub. Date: Oct. 15, 2020

(54) Solid State Extrusion and Bonding Tool

(71) Applicant: HYBOND AS, Trondheim (NO)

(72) Inventors: Øystein Grong, Ranheim (NO); Ulf Roar Aakenes, Stjørdal (NO); Tor Gunnar Austigard, Eide (NO)

(21) Appl. No.: 16/301,262

(22) PCT Filed: May 15, 2017
(86) PCT No.: PCT/EP2017/061644

§ 371 Date: Nov. 13, 2018

(30) Foreign Application Priority Data
May 13, 2016 (GB) 1608474.1
May 13, 2016 (GB) 1608475.8
May 13, 2016 (GB) 1608477.4
May 13, 2016 (GB) 1608478.2
May 13, 2016 (GB) 1608479.0
May 13, 2016 (GB) 1608481.6
May 13, 2016 (GB) 1608482.4
May 13, 2016 (GB) 1608483.2

(51) Int. Cl. B23K 20/12

(52) U.S. Cl. CPC B23K 20/1245; B33Y 10/00; B23K 20/128

(57) ABSTRACT

An extrusion and bonding tool for carrying out a hybrid metal extrusion and bonding process, the tool being for extruding an extrusion material and bonding the extrusion material to a substrate is provided. The tool may comprise a main body and a rotating die through which the extrusion material is extruded, wherein the rotating die moves relative to the main body of the tool, and wherein the extrusion material, in use, is extruded through the rotating die at a position that can vary about a circumferential path about a rotation axis of the tool. The tool may comprise an extrusion chamber; and a plurality of dies through which the extrusion material is extruded associated with the extrusion chamber, wherein the tool is arranged so that, in use, the extrusion material is received in the extrusion chamber and plasticised within the extrusion chamber before being extruded through one of the dies onto the substrate.

The invention relates to an extrusion and bonding tool, an extruder head for an extrusion and bonding tool, a kit of parts for forming a bonding and extrusion tool and a method of using a bonding and extrusion tool. In particular the present invention concerns a tool for performing solid-state metal processing that involves extruding a metal in solid state and bonding it to a metal substrate.

A number of techniques are known to be used to join two materials together. These techniques include fusion welding, like laser welding, electron beam welding, metal inert gas (MIG) welding, or tungsten inert gas (TIG) welding, friction welding, or a variant known as friction stir welding (FSW), brazing, riveting and adhesive bonding. However, there are various problems with these joining methods which decrease the quality of the joint or make the joining process difficult.

An alternative solid state method for joining components, for example as described in WO 03/043775, is known which is suitable for joining aluminium (or other light metal) components for structural applications. This method involves removing oxide from the surfaces to be joined immediately prior to extruding a filler material into a gap between the surfaces to be joined to bond the two surfaces to each other. This method may be referred to as a hybrid metal extrusion and bonding (HYB) process. This method is based on the principle of extrusion of a filler/bonding material, and the aim is to reduce or eliminate the disadvantages of prior art methods such as the excessive heating related to the FSW method and/or other porosity in the joint which can be created due to the use of shielding gas that is usually required in fusion bonding.

The basic idea behind the HYB process is to enable solid state joining of plates, such as aluminium plates, and profiles using filler material additions without leading to the formation of a weak/soft weld zone (which may be known as a heat affected zone (HAZ)) as in conventional fusion welding and FSW.

WO 2013/095160 discloses a device for performing hybrid metal extrusion and bonding (HYB) process. However, it has been found that this device has limitations, such as lack of flexibility and robustness, which may impede its ability to be used on a commercial scale. Therefore, there is a desire for an alternative device to perform the hybrid metal extrusion and bonding process.

In its broadest aspect the present invention provides an extrusion and bonding tool for extruding an extrusion material and bonding the extrusion material to a substrate.

The extrusion and bonding tool is for carrying out a solid-state hybrid metal extrusion and bonding process, wherein the tool is for extruding a metal extrusion material and bonding the extrusion material to a metal substrate.

The extrusion material and the substrate(s) may be made from metal. The extrusion material and the substrate(s) may be in the solid state when the tool is being used. The extrusion material and the substrate(s) may not be melted during the extrusion and bonding process performed by the tool. For example, the extrusion material may be extruded in the solid-state and the extrusion material may be deformed and/or plasticised within the extrusion chamber.

The extrusion material and/or substrate may be made of a metal that are plastically deformable and/or workable in their solid state. The extrusion material and/or substrate may be made of aluminium.

The tool may be arranged to extrude an extrusion material and deposit it on a substrate such that the extruded extrusion material bonds to the substrate.

The bonding and extrusion tool may be a tool for carrying out a hybrid metal extrusion and bonding (HYB) process.

The present invention may also comprise a method of using the bonding and extrusion tool. The method may comprise using the tool to extrude an extrusion material (e.g. solid extrusion material) and bonding the extruded extrusion material to a substrate. This may be performed when the extrusion material and the substrate are both in the solid state.

The bonding and extrusion tool (which may be referred to simply as a tool) may comprise any one or more of the following optional features.

The tool may comprise a rotating, i.e. rotatable, spindle. The rotating spindle is a spindle which, when in use, will rotate/be rotated. The spindle may be referred to as a rotating or rotatable spindle. The rotatable spindle may be arranged to, in use, contact and deform the substrate.

The present invention may provide an extrusion and bonding tool for extruding an extrusion material and bonding the extrusion material to a substrate, the tool comprising: a rotatable spindle, wherein the rotating spindle is arranged to, in use, contact and deform the substrate.

The present may provide an extrusion and bonding tool for carrying out a solid-state hybrid metal extrusion and bonding process, wherein the tool is for extruding an metal extrusion material and bonding the extrusion material to a metal substrate, the tool comprising: an extrusion chamber; and a rotatable spindle, wherein the rotatable spindle is arranged to, in use, contact and plastically deform the substrate, and wherein the tool is arranged so that, in use, the extrusion material is received in the extrusion chamber and plasticised within the extrusion chamber before being extruded through a die onto the deformed substrate due to rotation of the spindle.

When the tool comprises a spindle which is arranged to, in use, contact and deform the substrate, the rotating spindle may deform the substrate so as to promote bonding (e.g. metallic bonding) between the substrate and the extruded extrusion material (which may be referred to as extrudate).

The spindle may be arranged to plastically deform the substrate and/or remove a surface layer, such as a surface oxide, from the substrate. This may promote metallic bonding between the extrusion material and the substrate due to oxide dispersion and/or shear deformation.

The rotating spindle may not be fully submerged in the substrate (i.e. not surrounded on its entire circumference) but rather only an edge portion of the spindle may be used to deform the surface of the substrate. Thus the tool may not be a tool for friction stir welding in which a deforming component is submerged in the substrate and moves through a part of the bulk component near the surface to be joined. Instead, the present invention concerns using just a portion of the spindle to deform/remove a surface layer of the substrate so as to facilitate bonding.

Also in contrast to friction stir welding, in the case that the tool is used to join two components together, there may be a gap between the two components. Further, the extrusion material may be plasticised within the tool before it contacts the substrate rather than being plasticised by contact with the substrate as in typical friction stir welding involving a filler material.

The rotatable spindle (if present) may be rotated at a speed of 100 to 900 rpm, 200 to 600 rpm, 300 to 500 rpm or about 400 rpm. The precise speed may depend on a number of factors such as the tool advancement speed or the material properties.

One or more of these features (and optionally other features of the tool and method) may mean that the temperatures of the materials being joined with the present tool may be maintained at a lower temperature (such that the joint quality may be improved) than with friction stir welding. Also, the forces being applied by the tool and/or rotating spindle may be less.

The spindle may for example comprise a cutting (i.e. deformation) surface which deforms the substrate it is in contact with during use. The cutting surface may for example be a roughened and/or grooved surface on the part of the spindle which in use contacts the substrate. The cutting/deformation surface may be arranged, e.g. roughened, so that when it is moved against, such as rotated against, the substrate it deforms the substrate.

The cutting surface may be provided at a tip of the spindle.

In use, the spindle may rotate against the surface of the substrate to deform the substrate.

The rotating spindle, which may also be used for causing extrusion of the extrusion material, may conveniently also deform the substrate to promote bonding between the extruded material and the substrate. Thus, the tool may comprise a single moving part (i.e. a spindle) which performs multiple actions (e.g. preparing the substrate and extruding the extrudate).

In use the spindle may deform the substrate and form at least part of the extrusion chamber. Rotation of the spindle may cause deformation of the substrate and extrusion of the extrusion material. The spindle may thus have a dual function of causing extrusion of the extrudate and deformation of the substrate. These two steps may occur concurrently.

The spindle may be arranged to in use deform the substrate (whilst causing extrusion of the extrusion material) and then deposit extrudate onto the deformed substrate.

The spindle may be arranged such that when it rotates it can deform the substrate and cause extrusion of the extrusion material.

Rotation of the spindle may move the extrusion material into an extrusion chamber, move the extrusion material through the extrusion chamber and/or cause the extrusion material to be extruded through a die of the tool.

The extrudate may be extruded around the spindle. This may be within the body of the tool. The extrudate may be extruded before exiting the tool and coming into contact with the substrate to which it is bonded.

In use the tool may be moved in a direction so that it deposits a strip of extrudate on the substrate. The direction may be referred to as the travel direction.

The tool may comprise a support which can hold and move the device in a desired direction. The tool may be arranged to be moved at an approximately constant velocity.

As the tool is moved in the travel direction the tool may first deform the substrate and then deposit extruded material on the substrate. Thus, the method may comprise rotating the spindle, moving the tool, deforming the substrate using the rotating spindle and depositing extruded extrudate on the deformed substrate.

The tool may be arranged so that extrudate is extruded onto a surface that has already been deformed by the spindle.

The direction ahead of the tool which is where extrusion material is about to be deposited thereon may be referred to as an frontward direction and the direction behind the tool which is where the extrusion material has just been deposited may be referred to a rearward direction. In use the tool may be moved in a rearward to frontward direction. The spindle may be frontward of the location where the extrusion material is extruded, e.g. the die or where the extruded material is guided to. Thus, in use the spindle may be located ahead of the extruded material.

The extrudate may be deposited on the substrate in a position which is rearward of the spindle, i.e. behind the spindle relative to the direction of travel of the tool.

In use, the spindle (e.g. its axis of rotation) may be perpendicular, or substantially perpendicular, or within 15 degrees of perpendicular, to the direction of travel of the tool. In use, the tool may deposit a strip (e.g. bead/string) of extrudate on the substrate. The spindle (e.g. its axis of rotation) may be perpendicular, or substantially perpendicular, or within 15 degrees of perpendicular, to the direction in which the deposited extrudate extends and/or the top surface of the deposited extrudate.

In use, the spindle (e.g. its axis of rotation) may extend in a direction which is not parallel to the surface of the substrate.

If the substrate is considered to extend in a horizontal plane the spindle may be vertical, substantially vertical, or within 45 degrees of vertical.

The spindle may comprise a spindle tip which is arranged, in use, to contact and deform the substrate. The spindle tip may have a cutting surface on at least a portion of it.

The spindle tip may be the part of the spindle at or towards one end of the spindle, i.e. this is not necessarily just an end surface but a volume at the end of the spindle which may encompass the end surface.

For example, the spindle may comprise, or consist of, a spindle body and a spindle tip.

The spindle body may engage with and be driven by a drive mechanism which is used to cause the spindle to rotate.

The spindle may rotate continuously during operation. This is so that rotation of a deformation surface of the spindle may be continuous so that deformation can occur continuously and extrusion of the extrudate may be continuous.

The tool may comprise a drive mechanism. The drive mechanism may be arranged to rotate the spindle.

The spindle tip may be provided at one end of the spindle, i.e. on one end of the spindle body. The spindle tip may be the only part of the spindle which in use is in contact with the substrate.

The spindle tip may comprise a diameter which is smaller than a diameter of the spindle body.

The spindle tip may be tapered and/or conical.

The spindle may be an elongate member which in use is rotated about its central axis. The spindle may have a length that is greater than its diameter.

The tool may comprise an extrusion chamber. The tool may be arranged to receive extrusion material, extrude the extrusion material and deposit the extruded extrusion material on the substrate (which may have been deformed by the rotating spindle before the extrudate is deposited on the substrate). The extrusion material, which may for example be in the form of a wire, may be received in the extrusion chamber and plasticised within the extrusion chamber before being extruded through a die onto the substrate.

The extrusion material may be in the solid state when it is extruded. The extrusion material may be plastically deformed (i.e. plasticised) within the extrusion chamber and/or as it is forced through a die from the extrusion chamber. Thus the tool may be arranged so that the extrusion material is plastically deformed as it is extruded. This may result in deformation of the surface (e.g. surface oxide) of the extrusion material. This may thus result in the removal/dispersion/deformation of a surface layer of the extrudate. This may help promote metallic bonding between the extrudate and the deformed substrate.

Thus rotation of the spindle may cause a dispersion or deformation of the surface layers on both the substrate and the extrusion material.

The rotating spindle may form at least part of the extrusion chamber. For example, the rotating spindle may form at least two, or at least three, walls of the extrusion chamber.

The extrusion chamber may be formed by a groove on the surface of the spindle. The groove may extend around the entire circumference of the spindle.

The groove may be formed by machining a groove into the outer surface of the spindle.

Alternatively, the extrusion chamber may be formed, at least in part, by a component mounted and/or fixed on the spindle.

The spindle may comprise a larger diameter portion (which may be a die portion). This may form a bottom surface of the extrusion chamber.

The component mounted and/or fixed on the spindle may be spaced from the larger diameter portion to form the groove of an extrusion chamber.

The component mounted and/or fixed on the spindle may be an annular member that extends around the spindle and may be referred to as a spindle ring.

The spindle ring may be a separate component from the main body of the spindle so as to allow the assembly of the tool and in particular the extrusion chamber to be simplified.

The extrusion chamber may have moving walls on three sides (that may be provided by the rotating spindle) and a stationary wall on the fourth side.

The extrusion chamber having a plurality (such as three) moving walls means that it may exert a friction drag on the incoming solid extrusion material (e.g. aluminium filler wire) during rotation (while at least one wall is stationary and may resist the motion), the extrusion material is forced to flow towards the end of the extrusion chamber, i.e. a stationary abutment, and through one of the one or more die openings (which may for example be in the extruder spindle head and/or the stationary steel housing) when the spindle is set in motion.

The extrusion chamber may be a channel that extends around at least part of the circumference of the spindle. For example, the extrusion chamber may extend around at least 270 degrees of the spindle. The extrusion chamber may be the portion of the groove on the spindle that extends between an inlet point for the extrusion material and an abutment that forces the extrusion material out of the chamber.

The spindle may comprise an extrusion chamber portion. This portion may be located between the spindle body and the spindle tip.

The spindle may also comprise a die portion which provides at least part of one or more dies for the extrusion of the extrusion material. The die(s) in the spindle may comprise open die(s) and/or closed die(s).

The open dies, if present, may be in the forms of grooves in the surface of the spindle, on the die portion and/or spindle tip. The closed dies, if present, may be in the form of holes through the spindle, e.g. spindle die portion and/or spindle tip.

Thus, in a direction from an end which in use contacts a substrate, the spindle may comprise a spindle tip (which may be referred to as a deformation or cutting portion), a die portion (which provides one or more dies for the extrusion material), an extrusion chamber portion and a spindle body.

The tool may be arranged so that when the spindle rotates extrusion material is moved (e.g. pulled) into the extrusion chamber. The tool may be arranged so that rotation of the spindle moves the extrusion material through the extrusion chamber. Rotation of the spindle may force the extrusion material through a die.

The solid metal extrusion material may be deformed as it is moved into and through the extrusion chamber and/or as it is forced through a die out of the extrusion chamber.

The tool may comprise an extruder housing. The extruder housing may surround, or extend around, at least part, of the spindle. The extruder housing, or at least a part of the extruder housing, may together with the spindle form the extrusion chamber. The extruder housing may contact the spindle above and below the extrusion portion of the spindle to create the extrusion chamber.

The extruder housing may be a single component. Alternatively the extruder housing may comprise a plurality of components that may comprise for example an extrusion chamber constraint part (that forms one wall of the extrusion chamber) and an outer housing.

The extruder housing may contact the spindle at the die portion of the spindle. The extruder housing may together with the spindle form one or more dies through which the extrusion material is extruded.

The extruder housing and spindle may together form an extruder head which comprises an extrusion chamber and one or more extrusion dies.

Whilst the extruder housing and spindle may mate together to form the extrusion chamber, due to the high forces involved there may be leakage of extrusion material through the seal between the stationary housing and the rotating spindle. In view of this, the housing may be provided with a slot therethrough. The slot may permit the removal of extrusion material flash formed when such leakage occurs. The slot may be shaped to permit a machining tool to be inserted which can remove the extrusion material flash. Such a slot may allow extrusion material leakage problem to be solved without significantly affecting the mechanical integrity of the extruder housing.

The tool may comprise an abutment that at least partially blocks the extrusion chamber. The abutment may be a stationary abutment, i.e. fixed relative to the housing during use. The abutment may guide and/or force extrusion material out of the chamber through an extrusion die.

The abutment may be part of the extrusion housing. Alternatively, the abutment may be a separate part which can be attached, or fixed relative, to the extrusion housing. For example, the abutment may be fixed to the extruder housing by a mechanical interlocking device. The advantage of having the abutment as a separate part is that it can be easily replaced if it becomes worn over time or damaged.

The spindle may protrude from the extrusion housing, e.g. the spindle may protrude from the housing in an axial direction.

The spindle may protrude from the housing such that, in use, the spindle contacts the substrate.

The housing may comprise a surface which, in use, contacts the substrate. The surface may be a support/seal surface. However, the support surface of the extruder housing may not be arranged to deform the substrate. Instead the support surface may contact the substrate and support the tool on the substrate and create a seal on the substrate. The tool may be arranged so that when the support surface is in contact with the substrate, the spindle is in a position such that it contacts and deforms the substrate.

The support surface of the extruder housing may also be arranged to, in use, form a seal between the extruder head and the substrate. Thus, the support surface in this case may also be referred to as a sealing surface.

The bonding and extrusion tool may be for joining two substrates together. The tool may be used to join two substrates together. The method may comprise joining two substrates. The two substrates may each be made of metal. This may be the same metal or the two substrates may be different metals. For example the two substrates may both be aluminium (either of the same composition or different compositions). One substrate may be made of aluminium and one substrate may be formed of steel.

In the case that the tool is used to join two substrate, the substrates may be located such that they each have a face facing each other which are separated from each other by a gap. In use, the tool may be arranged to contact and deform this surface bounding the gap on one or both of the substrates and to deposit the extruded extrusion material onto the surfaces facing each other so as to fill the gap with extruded extrusion material and bond the two substrates together.

For example, if the tool is for joining for two aluminium components the spindle may contact and deform both substrates during use. If the tool is for joining a steel component to an aluminium component the rotating spindle may only deform the aluminium component. The spindle may not contact the steel component in use. Thus the spindle may only deform one substrate in the case that two substrates are being joined together.

In the case of fillet welding, the gap may in fact be a crevice near the point at which the two substrates that extend at an angle relative to each other contact each other.

When the tool is used to join two substrates together, the tip of the spindle may be received in a gap between the two substrates. Thus, the tool may be arranged so that, in use, the spindle extends into a gap (or crevice) between two substrates.

The substrate(s) may each be a surface of a component. The substrate may be a face of one of the components which faces the component to which it be joined by the tool.

The tool may be arranged to, in use, contact and deform two substrates and deposit the extruded extrusion material between the two deformed substrates so as to join two components together. The two components may be joined by the fact that the extrudate is bonded (i.e. metallically bonded) to a substrate of each of the components.

The tool may create a weld/joint between two substrates. This weld may fully penetrate a gap between the two components. The weld may comprise a cap layer. This may be a part of the weld that extends above the top surfaces of the components being joined. This may compensate for a possible loss of strength in the extrusion material during the processing and/or the fact that the extrudate is weaker than the components being joined.

The tool may be arranged so that the extruder housing contacts an outer surface of one or both of the substrates (i.e. a surface that in use faces the main body of the tool) and the tip of the spindle is received between the two substrates.

The tool may be arranged so that, in use, the spindle tip contacts and deforms at least part of the surfaces of one or both of the two substrates that face each other.

The spindle tip may be referred to as a submerged tip as in use it is received, i.e. submerged, in the gap between the two substrates.

The method may comprise locating two substrates (e.g. components such as plates) so that the faces of the substrates to be joined, face each other and are a distance apart to form a gap therebetween. The width of the gap may be less than the diameter of the tip of the spindle, e.g. so the spindle tip can contact and deform the substrates during use. This gap may alternatively be larger than the diameter of the tip of the spindle e.g. the spindle tip only is in contact with one of the surfaces.

The support surface of the extruder housing may be put in contact with a surface of each of the substrates (which may be a different surface to that which will be deformed and bonded to the extruded material). The spindle tip may be received in the gap between the two substrates. The spindle may be rotated so that the surface(s) of the substrate(s) in contact with the spindle are deformed and so that extrusion material is extruded from the extruder head into the gap after the surfaces have been deformed by the rotation of the spindle. The tool may be moved along the gap such that a continuous joint is formed between the substrate by the surfaces being deformed and then each bonded to the extruded (i.e. deformed solid) extrusion material.

The tool may be used to deposit a layer of material (i.e. extrudate) on the surface of a substrate. This may not be for the purpose of bonding the substrate to a second substrate but rather just so additional material is deposited on the substrate, e.g. for bead-on-plate deposition or additive layer manufacturing (which also may be referred to as additive manufacturing or 3D printing).

The extruder housing may be a stationary part of the tool, e.g. the extruder housing may not rotate. The spindle may rotate relative to the extruder housing.

The tool may comprise a die through which the extrusion material is extruded. The tool may comprise a plurality of dies (i.e. extrusion dies).

The plurality of dies may permit the extrusion of material from the extrusion chamber in parallel (with respect to time rather than necessarily direction). In other words, the tool may comprise a plurality of dies through which material in a single extrusion chamber can be extruded concurrently.

The presence of a plurality of dies means that the flow of aluminium out of the tool may be controlled. For example, extrudate may be extruded in multiple directions during operation, e.g. a single pass, of the tool. This may allow the extrudate to come into contact with the rotating spindle so as to promote mixing/bonding with the component to which the extrudate is being joined.

Extrusion material may enter the tool in a tangential/circumferential direction, and be extruded and/or guided in one or more of an axial direction, radial direction and/or oblique direction (i.e. at an angle to the axial and radial directions).

The presence of a plurality of dies means that the extrusion pressure to extrude the extrusion material may be lower than a device with a single die. This may thus reduce the risk of tool failure and/or excessive extrusion material flash formation. There may also be a reduced pressure drop (compared to having only one stationary die) in the die and underneath the die (e.g. in the gap if two components are being joined). This may allow the penetration depth of the filler material (e.g. as compared to the top of the gap into which extrusion material is directed) to be increased.

The plurality of dies may all be in communication with a single extrusion chamber.

Each of the plurality of dies may be for extruding extrudate onto the substrate.

The extrusion chamber may have a single inlet/entrance for extrusion material and plurality of outlets (i.e. dies) for extrusion material from the extrusion chamber.

The present invention may provide an extrusion and bonding tool for extruding an extrusion material and bonding the extrusion material to a substrate, wherein the tool comprises a plurality of dies.

In an aspect the present invention may comprise an extrusion and bonding tool for carrying out a hybrid metal extrusion and bonding process, the tool being for extruding an metal extrusion material and bonding the extrusion material to a metal substrate, the tool comprising: an extrusion chamber; and a plurality of dies through which the extrusion material is extruded associated with the extrusion chamber, wherein the tool is arranged so that, in use, the extrusion material is received in the extrusion chamber and plasticised within the extrusion chamber before being extruded through one of the dies onto the substrate.

The plurality of dies may be associated with a single extrusion chamber. Thus, there may be a single source of extrusion material which is forced through the extrusion chamber and through one of the plurality of extrusion dies.

The tool may comprise one or more fixed/stationary dies and/or may comprise one or more moving dies.

The present invention may provide an extrusion and bonding tool for extruding an extrusion material and bonding the extrusion material to a substrate, the tool comprising: a moving die through which the extrusion material is extruded.

In another aspect, the present invention may provide an extrusion and bonding tool for carrying out a solid-state hybrid metal extrusion and bonding process, wherein the tool is for extruding a metal extrusion material and bonding the extrusion material to a metal substrate, the tool comprising: a main body and a rotating die through which the extrusion material is extruded, wherein the rotating die moves relative to the main body of the tool, wherein the extrusion material, in use, is extruded through the rotating die at a position that can vary about a circumferential path about a rotation axis of the tool.

When the tool comprises an extrusion chamber, some extrusion material, when in the extrusion chamber, may be in contact with the moving die from the point at which it enters the extrusion chamber and may be forced through the moving die once the extrusion material has moved a certain distance around the extrusion chamber and the pressure in the extrusion chamber has increased above a threshold extrusion pressure.

In another aspect, the present invention provides an extrusion and bonding tool for carrying out a hybrid metal extrusion and bonding process, the tool being for extruding a metal extrusion material and bonding the extrusion material to a metal substrate, the tool comprising: an extrusion chamber; and a moving die through which the extrusion material is extruded, wherein some extrusion material, when in the extrusion chamber, is in contact with the moving die from the point at which it enters the extrusion chamber and is forced through the moving die once the extrusion material has moved a certain distance around the extrusion chamber and the pressure in the extrusion chamber has increased above a threshold extrusion pressure.

The presence of one or more moving dies may allow the extrusion pressure required to force the extrusion material out of the die to be lower. This may thus reduce the risk of tool failure and/or excessive extrusion material flash formation. There may also be a reduced pressure drop (compared to having only one stationary die) in the die and underneath the die (e.g. in the gap if two components are being joined). This may allow the penetration depth of the filler material (e.g. as compared to the top of the gap into which extrusion material is directed) to be increased.

When the tool comprises an extrusion housing, one or more dies may be provided in the extrusion housing. These may each be a stationary die.

When the tool comprises a spindle, one or more dies may be provided in the spindle. These may each be a moving die. Thus the rotatable spindle may form (i.e. provide the opening for) the die for the extrusion of the extrusion material.

Thus the tool may comprise one or more stationary dies and/or one or more moving dies.

A moving die may be a die which moves relative to the main body and/or outer housing of the tool. For example, the moving die may rotate. The moving die may thus be referred to as a rotating die. A moving die may be a die in which extrusion material is forced through the die at a position that may vary relative to the main body and/or outer housing of the tool. For example, if the moving die is a rotating die, the extrusion material may be extruded through the die at a position that can vary about a circumferential path about a rotation axis e.g. of the spindle.

The moving die (i.e. the exit from the extrusion chamber) may move relative to the entrance to the extrusion chamber.

For example, the extrusion chamber may extend around a portion of the rotating spindle. Extrusion material may enter the extrusion chamber at an extrusion chamber entrance in a circumferential and/or radial direction. The location of the entrance may be fixed relative to the main tool body/The moving die may be located on the spindle and may rotate relative to the extrusion chamber and thus may move circumferentially relative to the extrusion chamber entrance.

Extrusion material may move a non-fixed (i.e. variable) distance through the moving die before being extruded through the moving die. The distance may depend on factors such as the pressure in the extrusion chamber and the properties of the material being extruded.

The moving die may move during extrusion and/or operation of the tool.

One or more moving dies and/or guide may be in the form of an open groove that is helicoid-shaped. This may control the flow of aluminium out of the tool. For example it may guide the extrudate inwards towards the centre of the tool where a rotating spindle may be located.

The helicoid die and/or guide may act as an “Archimedes screw” during rotation of the component, e.g. spindle, on which it is located. This may increase the penetration depth of extrudate passed through the helicoid die and/or guide.

Each die (moving or stationary) may be in communication with the extrusion chamber and extrusion material may be extruded through the moving die when the pressure inside the extrusion chamber at the position of the die is higher than a threshold pressure. In an embodiment, the tool may comprise a single stationary die in the extruder housing and a plurality of moving dies in the rotating spindle.

In use, extrusion material may be pulled into the extrusion chamber and forced in a path around a rotating spindle. The extrusion material, when in the extrusion chamber, may be in contact with one of the moving dies from the point at which it enters the extrusion chamber and be forced through the moving dies once the extrusion material has moved a certain distance around the extrusion chamber and the pressure in the extrusion chamber has increased above a threshold extrusion pressure.

The tool may be arranged so that in use the extrusion material is extruded through the moving die(s) in a location which is rearward of the spindle tip.

However, extrusion material may be extruded through the one or more moving die(s) at a location that is frontward of the spindle.

Extrusion material may start to be extruded through a moving die at a location frontward and/or sideward (i.e. not rearward) of the spindle. In this case, the extrusion material may be deposited or guided from the die to a location that is rearward of the spindle.

The one or more stationary die(s) may be located frontward and/or rearward of the spindle.

At the end of the extrusion chamber there may be an abutment. The extrusion material in the extrusion chamber may reach the abutment and then be forced out through the stationary die(s) and/or the moving die(s).

The tool may comprise one or more guides (which may be referred to as an extrudate guide). The guide(s) may guide the extruded extrusion material after it has passed through a die.

The presence of a guide means that the flow of aluminium out of the tool may be controlled. This may allow the extrudate to come into contact with the rotating spindle so as to promote mixing/bonding with the component to which the extrudate is being joined.

The tool may be arranged to guide the extrudate in a direction which is different to the direction in which it is extruded through the die.

For example, the extrusion material may be extruded in an axial, or substantially axial direction, and may then be guided in a direction which is non-axial (such as obliquely or radially).

The tool may comprise a guide which is arranged so that, in use, extrusion material extruded through the die is guided in a direction towards a central axis of the tool.

The tool may comprise a guide (e.g. a channel) which is arranged so that, in use, extrusion material extruded through the die is guided in a direction rearward of the tool. This may be a radial direction relative to the spindle and may be in a direction away from the spindle. This direction may be substantially perpendicular to the central axis of the tool.

The present invention may provide an extrusion and bonding tool for extruding an extrusion material and bonding the extrusion material to a substrate, the tool comprising: a die, wherein the tool is arranged so that, in use, extrusion material extruded through the die is directed in a direction that is different to the direction in which the extrudate was extruded.

In another aspect the present invention may provide an extrusion and bonding tool for extruding an extrusion material and bonding the extrusion material to a substrate, the tool comprising: a die, wherein the tool is arranged so that, in use, extrusion material extruded through the die is directed towards a central axis of the tool.

In another aspect the present invention may provide an extrusion and bonding tool for carrying out a solid-state hybrid metal extrusion and bonding process, the tool being for extruding a metal extrusion material and bonding the extrusion material to a metal substrate, the tool comprising: a die, and a guide; wherein the guide is arranged so that, in use, extrusion material extruded through the die is directed/guided by the tool in a direction that is different to the direction in which the extrudate was extruded through the die and/or guided towards a central axis of the tool.

The present invention may provide an extrusion and bonding tool for extruding an extrusion material and bonding the extrusion material to a substrate, the tool comprising: a die, and a guide, wherein the guide is arranged so that, in use, extrusion material extruded through the die is guided in a direction away from a central axis of the tool.

When the tool comprises a rotating spindle, the guide may be arranged so that, in use, extrusion material extruded through the die is guided in a direction towards a central axis of the rotatable spindle.

The guide may be part of the die and/or may be a channel, groove or hole which is located in a downstream (relative to the direction of movement of the extrudate) location from the die.

The guide may be one or more grooves on the spindle.

The guide may be a channel in the extruder housing.

In another aspect the present invention may provide an extrusion and bonding tool for extruding an extrusion material and bonding the extrusion material to a substrate, the tool comprising: a rotatable spindle, a die, and a guide, wherein the guide is arranged so that, in use, extrusion material extruded through the die is guided in a direction towards a central axis of the rotatable spindle.

The tool may comprise a plurality of guides. Each guide may be provided in respect of a die. Each guide may direct the extrudate extruded from the respective die.

When the tool comprises a plurality of guides, at least two, or each guide may guide extrudate in a different direction. These may be non-parallel directions. For example, the extrudate from one die may be guided in a direction parallel to the central axis of the tool/rotation axis of the spindle and the extrudate from another (or a plurality of dies) may be guided in a direction at an angle to the central axis of the tool/rotation axis of the spindle. The direction at an angle to the central axis of the tool/rotation axis of the spindle may be such that the extrudate is directed at an angle towards (or away from) the central axis of the tool/rotation axis of the spindle and/or may be such that the extrudate is directed at an angle around the spindle such that the extrudate is directed in at least a partially circumferential direction.

The guide(s) may direct extrudate towards the tip of the spindle at least a portion of which (e.g. the sides of the spindle tip) in use contacts the substrate. Additionally or alternatively, the guide(s) may direct extrudate to a location which is rearward of the spindle.

Extrudate from a stationary die may be guided in a different direction to extrudate from a moving die. The tool may comprise a guide which guides extrudate from the stationary die in a direction parallel (or substantially parallel) to the axis of the tool/spindle and/or may comprise a guide which guides extrudate in a direction towards the central axis of the tool/spindle.

The tool may be arranged so that, in use, extrudate is guided to the surface of the substrate after it has been deformed by the rotating spindle.

The tool may continuously extrude the extrusion material. This may be achieved by continuously rotating the spindle.

The tool may be arranged so that, in use, it can be moved such that a strip of extrudate is deposited on the deformed substrate such that a strip of extrudate is bonded to the substrate.

The substrate may be a metal, e.g. light metal, such as aluminium (including aluminium alloys).

When the tool is used for joining two substrates together the two substrates may be the same material. Alternatively, the two substrates may be different materials. For example, one substrate may be a light metal such as aluminium and the other substrate may be a non-light metal such as steel.

The spindle may have a radius (e.g. the body of the spindle) of 1 to 20 mm, 1 to 10, 2 to 7 mm or about 5 mm.

The spindle may be made of a suitable heat and wear resistant, high strength material such as steel.

The extrusion housing may be made of a suitable heat and wear resistant, high strength material such as steel.

Due to its small radius the spindle may be prone to shear fracture. Therefore, the tool may be designed to minimise shear forces acting on the rotating spindle during extrusion and bonding. For example, the spindle may be made from steel. The spindle may be made from a material, such as steel, with a shear strength of greater than 700 MPa, greater than 800 MPa, or a shear strength of 850 MPa or greater.

The tool may be designed to minimise friction between the spindle and extrusion housing. For example, the area of contact between these two components may be minimised.

The contact area between the extruder housing and the substrate when the tool is in use, may be minimised. This may reduce friction which could damage the housing and/or substrate and allows the contact pressure to be higher for a given force so as to create a better seal and minimise leakage of the extruded extrusion material from its desired deposition location. The pressure across the contact area between the extruder housing and the substrate when the tool is in use may be up to the flow stress of the extrusion material being deposited.

The tool may comprise coatings on the surfaces of the spindle and the extruder housing which contact each other when the tool is assembled and in use. These coating may be for the purpose of reducing friction between these two parts which move relative to each other. Thus these coatings may be low friction coatings.

The tool may also comprise a coating on the surfaces of the tool that contact the substrate during use. This may comprise parts of the tool, such as the extrusion housing and sealing protrusion, which seal against the substrate when the extrusion and bonding is occurring.

The abutment which guides extrusion material out of the extrusion chamber may comprise a coating on the surface which in use contacts the extrusion material.

The coating may comprise a high wear resistance coating and/or a low friction coating.

The coating may be a dual coating with a high wear resistance layer, which may be an underlayer, and a low friction coating, which may be the surface layer.

The high wear resistance layer may be an AlTiN type coating. The low friction coating may be a diamond-like carbon coating, e.g. a W-DLC type coating.

The extrusion chamber, or at least the moving walls of the extrusion chamber may be uncoated, or at least not comprise a low friction coating. Thus the extrusion chamber may be at least partially uncoated. This is to ensure that there is sufficient sticking friction between the extrusion material and the extrusion chamber to obtain a high enough drag force on the incoming extrusion material to allow the extrusion to occur.

The tool may operate, or be designed to operate, at room temperature. The tool may not comprise any heating means. The tool may be designed to control heat conduction from the extrusion chamber through the die opening and spindle tip to the substrate on which the extrusion material is deposited.

It may be desirable for there to be a sufficient supply of heat from the extruder to the underlying substrate(s) to avoid excessive work hardening of the extrusion material during bonding, yet it is desirable that the heat is supplied only to a restricted volume of the substrate underneath the extruder head.

Heat may be supplied via the extrudate and through conduction and mechanical work of the extruder housing and/or rotating spindle tip in contact with the substrate.

The tool, substrate and/or deposited extrudate may be cooled during use. For example, the tool may be arranged so that cooling (e.g. water cooling) of the extruder housing, substrate and/or deposited extrudate can be performed during use.

The tool may comprise a water cooling means. The cooling means may use a fluid other than water. For example the cooling means may be CO₂ or helium.

The cooling fluid may be directed against the tool and/or extruded material for example. In the case of CO₂ the fluid may be a liquid within the tool and then transform into a gas just before, as or after it impinges on the part (e.g. tool itself or the materials being bonded) to be cooled.

The extrusion material may be a filler material which fills a gap between two substrates. The extrusion material may join two materials together. This may be achieved by the extruded material bonding to both substrates.

The extrusion material may be a filler material, such as a filler wire.

The extrusion material may be aluminium (including aluminium alloys). The extrusion material may be the same material as the substrate (or at least one of the substrates in the case the extrusion material is used to join two components together). The extrusion material may be different to the material of the substrate. The tool may be used to deposit a material on the surface of the substrate that is different to the material of the substrate. For example, the tool may be used to deposit an aluminium extrusion material on a steel plate.

The extrusion material may change during use. For example, the tool may initially deposit one material and then deposit a different material. The extrusion material may change depending on what the tool is being used for.

The tool may be arranged so that the extrusion material may be fed into the extrusion chamber through the extruder housing (e.g. via an inlet to the extruder housing). The extrusion material may be fed into the extrusion chamber in a tangential direction.

When the bonding and extrusion tool is for joining two substrates together, the rotating spindle may contact and deform both substrates. Alternatively, the rotating spindle may deform only one of the substrates. For example, if two substrates formed of different materials, such as steel and aluminium substrates, are being joined, the rotating spindle may only contact and deform only the softer, e.g. aluminium, substrate.

Alternatively, the rotating spindle may not deform either surface and instead surface deformation of the substrate may be achieved by some other means such as an additional scraper or by force of the deposition of the extruded material such as caused by forcing a width of extrusion material between two the substrates which is wider than the gap between the two substrates.

Deformation of the substrate may be achieved by shear deformation caused by the force of extruding the extrusion material.

The bonding and extrusion tool may be for depositing a layer of material on a substrate to form an additional layer thereon. The tool may be for forming an additional layer on the surface of the substrate.

For example, if the substrate is a plate, the tool may deposit and bond extruded extrusion material onto the top planar surface of the plate.

The tool may be used for a plurality of different applications. For example, the tool may be used to extrude extrusion material between two substrates (e.g. plates or components) to join the two substrates together and the tool may be used to deposit material on the surface of a substrate (e.g. the surface of a plate or component).

The tool may be for butt joining two components, fillet joining (which encompasses, T, corner and lap joining) two components, multi-pass joining two components, depositing a stringer bead on the surface of a component, depositing a layer on a substrate, double sided joining and/or additive layer manufacturing.

When the tool is used for a plurality of different applications the tool may comprise interchangeable parts which can be changed depending on the application the bonding and extrusion tool is to be used for.

For example, the tool may comprise an extruder head which can be changed depending on the application the tool is intended to be used for. Thus, a plurality of extruder heads may be provided. Each extruder head may be for a different bonding and extrusion application. Each extruder head may have a specific geometry suited for the application the tool will be used for.

Each extruder head may have moving and/or stationary dies and may have a number of (e.g. one or more) dies that is chosen based on the application.

For example, an extruder head designed for butt joining, an extruder head designed for fillet joining, an extruder head designed for bead-on-plate deposition, and/or an extruder head designed for additive layer manufacturing may each be provided.

Thus, the tool may comprise a plurality of interchangeable extruder heads which are each designed for a different application. Each different application involves extruding an extrusion material and bonding it to a substrate.

Alternatively, the tool may be used for a single application and may have an extruder head which is designed for that application.

Because the tool can be used for a plurality of different applications (including butt joining, fillet joining, multi-pass joining, double sided joining, bead-on-plate deposition, and/or additive layer manufacturing) the tool may be used in applications which require a combination of these different techniques. For example, the tool may be used for plate surfacing which may be performed by depositing separated beads on the substrate and then butt joining adjacent deposited beads together. The tool may be used for multiple pass joining which may comprise fillet joining, depositing a bead on the fillet joint and butt joining the deposited bead on each side to the substrates being joined.

Each extruder head may comprise a rotating spindle and an extruder housing.

The tool may comprise a drive mechanism which can engage with the, or each, extruder head. The drive mechanism and an extruder head may together form the bonding and extrusion tool.

The spindle may comprise a locking mechanism for engaging the spindle with the drive mechanism. The spindle ring may provide the locking mechanism.

Thus, in another aspect the present invention may provide a kit of parts for a bonding and extrusion tool carrying out a solid-state hybrid metal extrusion and bonding process, the tool being for extruding an extrusion material and bonding the extrusion material to a substrate, the kit of parts comprising: a drive mechanism; and a plurality of extruder heads, wherein each extruder head can be driven by the drive mechanism; and wherein the drive mechanism and one of the extruder heads together form the bonding and extrusion tool.

The drive mechanism may, in use, engage with the rotating spindle and rotate the spindle within the extruder housing.

The extruder head may be attached to the tool such that the drive mechanism engages with the spindle.

The kit of parts is arranged so that the drive mechanism and single one of the heads is used to form the tool. When the drive mechanism and a single one of the heads is engaged to form the tool the other heads may be located separately be ready to be used if it is desired for the head of the tool to be changed (e.g. if the joining process to be performed is to be changed).

The extruder head may comprise a spindle tip which protrudes from the extruder housing such that in use, it contacts and deforms the substrate. For example, when the tool is used to join two substrates (e.g. by butt joining or fillet joining) the spindle may be designed be received in a gap (or crevice) between the two substrates being joined.

When the extruder housing comprises a support surface the surface being deformed may, for example in the case when two substantially parallel substrates are being joined together, be a different surface to the surface on which the support surface rests.

When the rotating spindle is arranged to in use deform the substrate, the rotating spindle may contact and deform a different surface of the substrate to the surface that the support surface is received on.

The present invention may provide an extruder head which is designed for butt joining two substrates. Such an extruder head may be referred to as a butt joining extruder head.

A butt joining extruder head may be designed to join two substrates which are substantially in the same plane as each other and separated from each other by a gap. The substrates may each have an upper surface, which is the surface that faces the main body of the tool during use. The substrates each may have a join surface which face each other and bound the gap between the two substrates. The join surfaces may be parallel or extend at an angle relative to each other. The upper surface and join surfaces of each of the two substrates may be at an angle to each other, such as between 45 and 90 degrees to each other.

The butt joining extruder head may comprise a support/sealing surface which in use contacts and seals against the top surface (i.e. surface which faces the main body of the tool) of the substrates. The sealing surface may reduce extruder material flash formation on the surface of the substrates during joining. The spindle may protrude out of the extrusion housing so that in use it contacts the join surfaces of the two substrates. The spindle may comprise a deformation portion. The deformation portion may have a diameter which is smaller than the die portion, extrusion chamber portion or main body of the spindle. The deformation portion, in use, may be received in the gap between the two plates and contact one or both of the join surfaces so as to cause deformation.

The seal surface may be planar. The sealing surface may extend in at least a U shape around the rotatable spindle. The sealing surface may extend around the rearward side of the spindle and be open at an frontward side of the spindle. The extruder housing may comprise a stationary die opening which extends through the seal surface on the rearward side. The extruder housing may comprise a stationary die opening which may be located on a rearward side of the spindle.

The spindle may comprise a die portion with a plurality of moving dies therein.

The butt joining extruder head may comprise a sealing protrusion (which may be referred to as a skirt). The sealing protrusion may be provided on the extruder housing (either as an integral part of the extruder housing or a part that may be attached and replaced as desired). The sealing protrusion may be designed to be received in the gap between the two substrates to be joined during use. The sealing protrusion may have a diameter which is smaller than the diameter of the deformation portion of the spindle which in use is received in the gap between the two substrates and contacts and deforms the substrates. The sealing protrusion may have a diameter which is the same as, or smaller than, the gap between the two substrates.

The sealing protrusion may be located on a frontward side of the spindle. The sealing protrusion may be arranged to prevent extrudate from escaping on a frontward side of the spindle during extrusion and joining. Additionally or alternatively, the sealing protrusion may be arranged so that the substrate material being machined off by the cutting surface (i.e. tip) of the rotating spindle is recirculated inside the gap and can become an integrated part of the joint.

The extrusion head may comprise a replaceable abutment which is received and locked into the extruder head so as to close the extrusion chamber formed between the spindle and the extruder housing. The abutment may be located so that in use it causes the extrusion material to be extruded through the stationary die. The abutment may also, in use, cause the extrusion material to be extruded through the moving dies as they approach the abutment.

The present invention may provide an extruder head which is designed for fillet joining two substrates. Such an extruder head may be referred to as a fillet joining extruder head.

A fillet joining extruder head may be designed to join two substrates which extend at an angle relative to each other. The substrates may each have a first surface, which is the surface that faces the main body of the tool during use. The first surfaces of the two substrates may be at an angle to each other. The substrates each may have a join portion which is located near/in close proximity to the other substrate. A crevice or gap may be formed between the two components to be joined when they are in contact.

The fillet joining extruder head may comprise a support/sealing surface which in use contacts and seals against the two substrates. The sealing surface may reduce extruder material flash formation on the surface of the substrates during joining.

The seal surface may comprise a first seal portion which in use seals against a first of the two substrates and a second seal portion which in use seals against the other (i.e. a second) of the two substrates.

The first seal portion and second seal portion may have surfaces which extend at an angle between each other. The angle between the planes of the surfaces of the first and second seal portion may be similar (such as within 10 degrees) or the same as the angle between the first surfaces of the two substrates being joined.

The spindle may protrude out of the extrusion housing so that in use it contacts the first surfaces of the two substrates at or near the point at which they contact each other and the surfaces of the crevice/gap near the join. The spindle may comprise a deformation portion which in use contacts and deforms, one or both, of the substrates. The deformation portion may be conical and/or taper shaped, i.e. the tip of the spindle may be tapered. This is so that the deformation portion can contact and deform the substrates at a location close to where the substrates being fillet joined join.

The extruder housing may comprise a stationary die opening which extends through the seal surface on the rearward side. The extruder housing may comprise a stationary die opening which, in use, is located on a rearward side of the spindle.

The spindle may comprise a die portion with a plurality of moving dies therein. The fillet joining extruder head may comprise a sealing protrusion (which may be referred to as a nose). The sealing protrusion may be provided on the extruder housing (either as an integral part of the extruder housing or a part that may be attached and replaced as desired). The sealing protrusion may be located between the first and second sealing surfaces on a frontward side of the spindle. The sealing protrusion may be arranged to prevent extrudate from escaping on a frontward side of the spindle during extrusion and joining. Additionally or alternatively, the sealing protrusion may be arranged so that the substrate material being machined off by the cutting surface (i.e. tip) of the rotating spindle is recirculated inside the gap and can become an integrated part of the joint.

The extrusion head may comprise a replaceable abutment which is received and locked into the extruder head so as to close the extrusion chamber formed between the spindle and the extruder housing. The abutment may be located so that in use it causes the extrusion material to be extruded through the stationary die. The abutment may also, in use, cause the extrusion material to be extruded through the moving dies as they approach the abutment.

The present invention may provide an extruder head which is designed for bead-on-plate deposition. Such an extruder head may be referred to as a bead-on-plate extruder head.

A bead-on-plate extruder head may be designed to deposit a bead of extrudate on the surface of a substrate. The substrate may have a deposition surface, which is the surface that faces the main body of the tool during use and the surface on which the extruded extrusion material will be deposited.

The bead-on-plate extruder head, e.g. the extruder housing, may comprise a support/sealing surface which in use contacts and seals against the deposition surface. The sealing surface may reduce extruder material flash formation on the deposition surface.

The seal surface may have a geometry which matches the shape of the deposition surface. If the substrate is a plate and the deposition surface is planar the seal surface of the extruder head may be planar.

The seal surface may comprise a channel therethrough. The channel may be located on a rearward side of the spindle/tool. This channel may permit, during use, extrudate to flow therethrough to permit the bead to be formed on the substrate.

The channel may extend in a rearward and/or radial direction. The channel may extend in a direction parallel to the surface of the deposition surface.

The extruder housing may comprise a recess on the surface that in use faces the substrate. The recess may be designed to accommodate a bead, or at least part of a bead, which has already been deposited by the tool. This may allow the beads to be deposited close together without the tool hitting an adjacent bead.

The recess may have the same height as, or a height greater than, the channel. This is so that the height of the recess has the same height as, or a height greater than, a deposited bead. This is so that the bead can be accommodated within the channel without impairing the deposition of further beads.

The width of the protrusion between the channel and the recess may determine the minimum distance between two beads deposited by the tool.

The spindle may protrude out of the extrusion housing so that in use it contacts and deforms the deposition surface when the seal surface is in contact with the deposition surface. The spindle may comprise a deformation surface on the end which in use contacts and deforms, the substrate. The deformation surface may be the same width or wider than the channel. This is so that the bead is deposited on an area of the substrate which is all deformed by the spindle.

The extruder housing may comprise a stationary die opening which extends into the channel through the seal surface. The extruder housing may comprise a stationary die opening which, in use, is located on a rearward side of the spindle.

The spindle may not have any moving dies therein. Thus, the only die may be the stationary die in the extruder housing. Thus, the spindle may be designed to prevent leakage of extruder material in the axial direction rearwards.

In certain embodiments the spindle may comprise moving dies.

The extrusion head may comprise a replaceable abutment which is received and locked into the extruder head so as to close the extrusion chamber formed between the spindle and the extruder housing. The abutment may be located so that in use it causes the extrusion material to be extruded through the stationary die.

The present invention may provide an extruder head which is designed for additive layer manufacturing. Such an extruder head may be referred to as an additive layer manufacturing extruder head.

An additive layer manufacturing extruder head may be designed to deposit a bead of extrudate on a bead that has already been deposited on substrate. Thus, the substrate that the tool deposits onto may be a bead already deposited.

The bead may have a deposition surface, which is the surface that faces the main body of the tool during use and the surface on which the extruded extrusion material will be deposited.

The additive layer manufacturing extruder head may comprise a support/sealing surface which in use contacts and seals against the deposition surface. The sealing surface may reduce extruder material flash formation on the deposition surface.

The seal surface may comprise a channel therethrough. The channel may be located on a rearward side of the spindle/tool. The channel may extend in a radial direction. This channel may permit, during use, extrudate to flow therethrough to permit the bead to be formed.

The channel may be the same width as, or narrower than, the bead on which the extrudate is being deposited.

The additive layer manufacturing extruder head may comprise a sealing rim which extends away from the main body of the tool on either side of the channel. The sealing rim may be provided so that in use it extends down the sides of the bead on which the new bead is being deposited. This may help ensure that the extrudate is correctly deposited on the pre-existing bead and may help guide the tool to ensure that the extrudate is deposited precisely on top of the pre-existing bead.

The spindle may protrude out of the extrusion housing so that in use it contacts and deforms the deposition surface when the seal surface is in contact with the deposition surface. The spindle may comprise a deformation surface on the end which in use contacts and deforms, the substrates. The deformation surface may be the same width or wider than the bead on which the extrudate is being deposited. This is so that the upper surface of the substrate (i.e. the pre-existing bead) is all deformed by the spindle.

The extruder housing may comprise a stationary die opening which extends into the channel through the seal surface. The extruder housing may comprise a stationary die opening which, in use, is located on a rearward side of the spindle.

The spindle may not have any moving dies therein. Thus, the only die may be the stationary die in the extruder housing.

In certain embodiments the spindle may comprise moving dies.

The extrusion head may comprise a replaceable abutment which is received and locked into the extruder head so as to close the extrusion chamber formed between the spindle and the extruder housing. The abutment may be located so that in use it causes the extrusion material to be extruded through the stationary die.

The present invention may provide a set up comprising the extrusion and bonding tool and the substrate. The substrate may comprise two substrates which are to be joined together, these two substrates may be substantially parallel (in the case of butt joining) or non-parallel (in the case of fillet joining), the surface of a plate (in the case of bead-on-plate deposition) or a bead (in the case of additive layer manufacturing).

Each of the above described aspects of the invention may be independently patentable of the features of the other aspects. Also, any one or more of the above described features, including optional features, may be combined with any aspect of the invention and any aspects of the invention may be combined.

Certain preferred embodiments of the present invention will now be described by way of example only with reference to the accompanying drawings, in which:

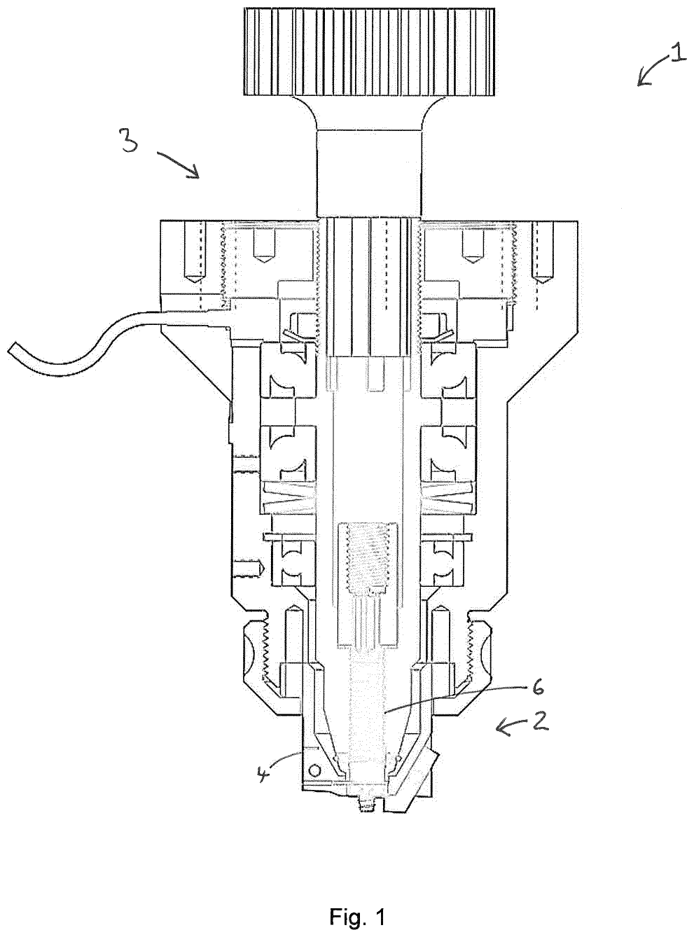

FIG. 1 shows a bonding and extrusion tool;

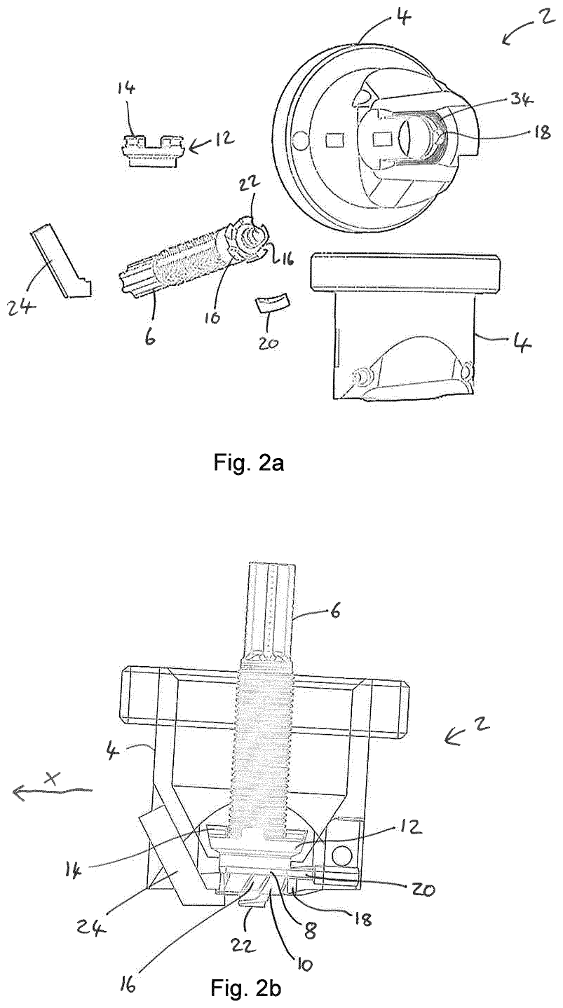

FIG. 2a shows the parts of a first extruder head;

FIG. 2b shows the first extruder head in partial cross-section;

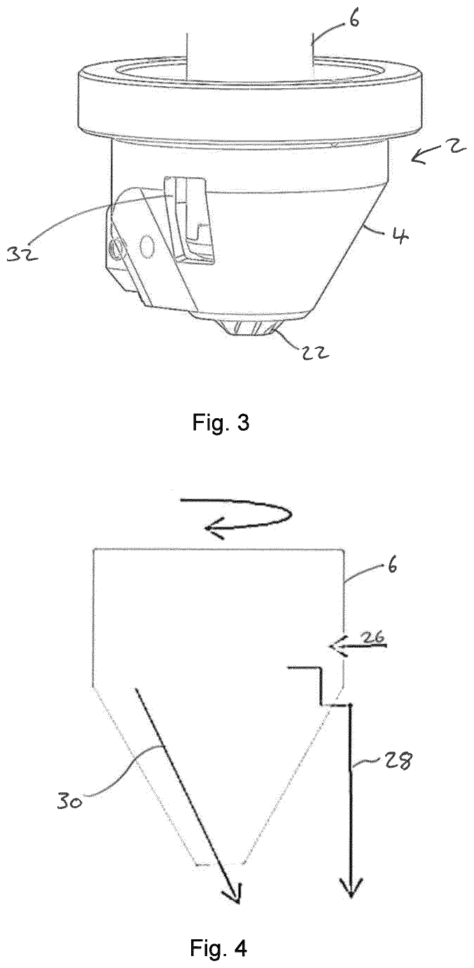

FIG. 3 shows an extruder head;

FIG. 4 shows a schematic spindle tip of an extruder head;

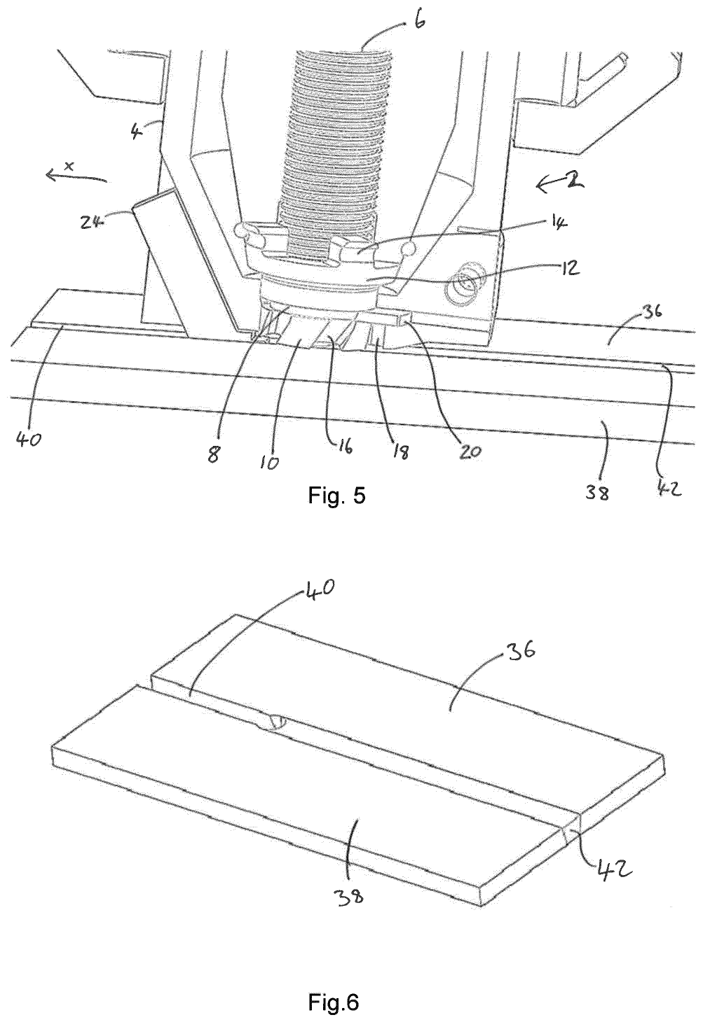

FIG. 5 shows the first extruder head being used;

FIG. 6 shows a butt joint;

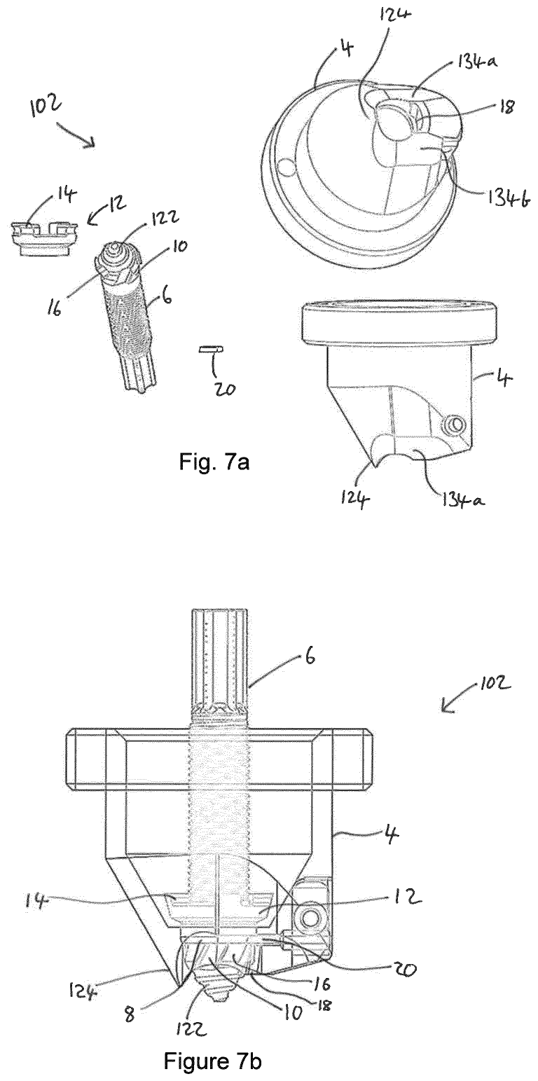

FIG. 7a shows the parts of a second extruder head;

FIG. 7b shows the second extruder head in partial cross-section;

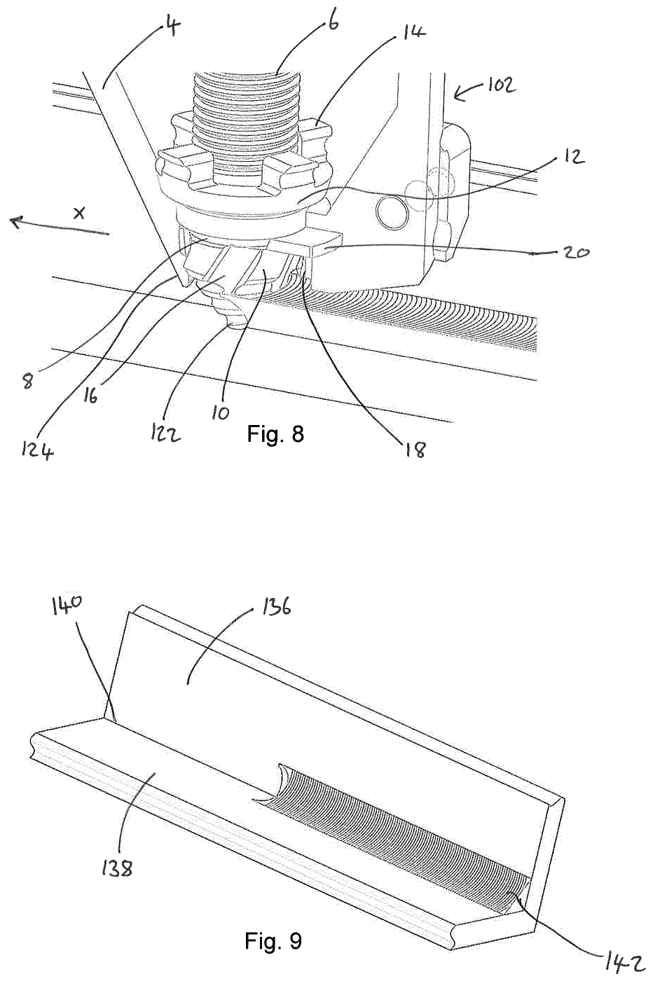

FIG. 8 shows the second extruder head being used;

FIG. 9 shows a fillet joint;

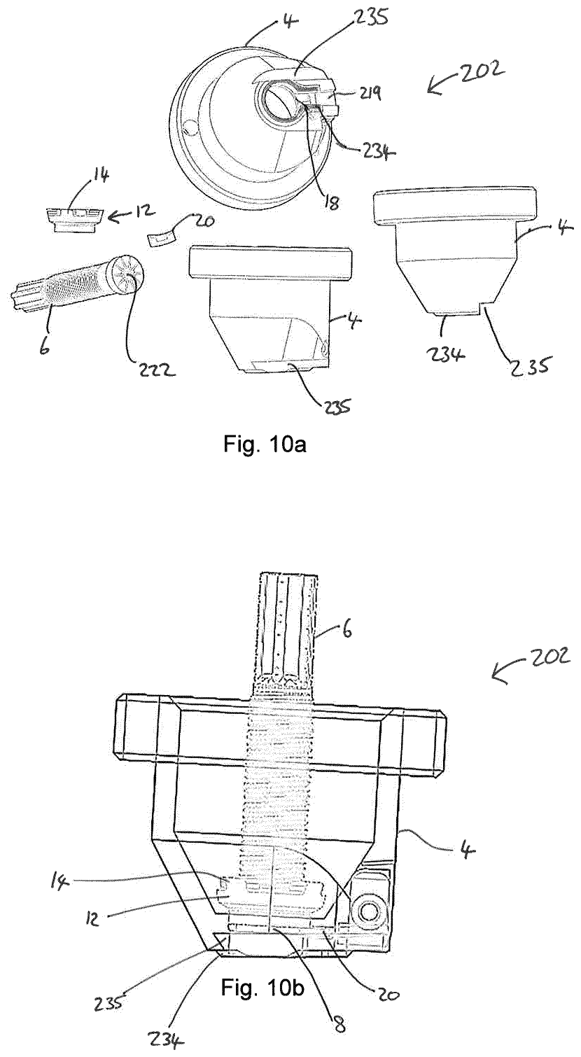

FIG. 10a shows the parts of a third extruder head;

FIG. 10b shows the second extruder head in partial cross-section;

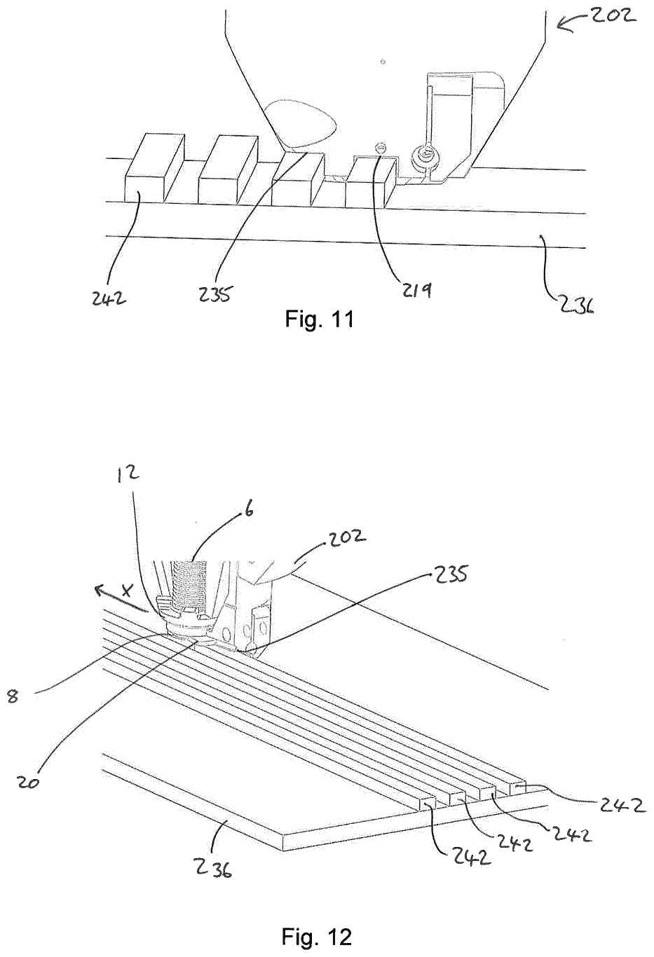

FIG. 11 shows the third extruder head being used;

FIG. 12 shows in partial cross section the third extruder head being used;

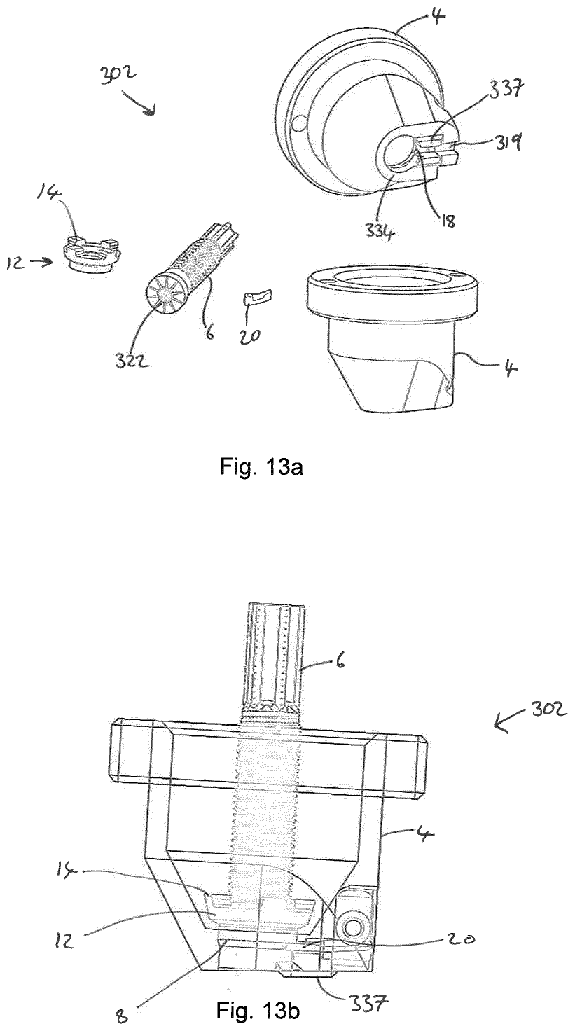

FIG. 13a shows the parts of a fourth extruder head;

FIG. 13b shows the fourth extruder head in partial cross-section;

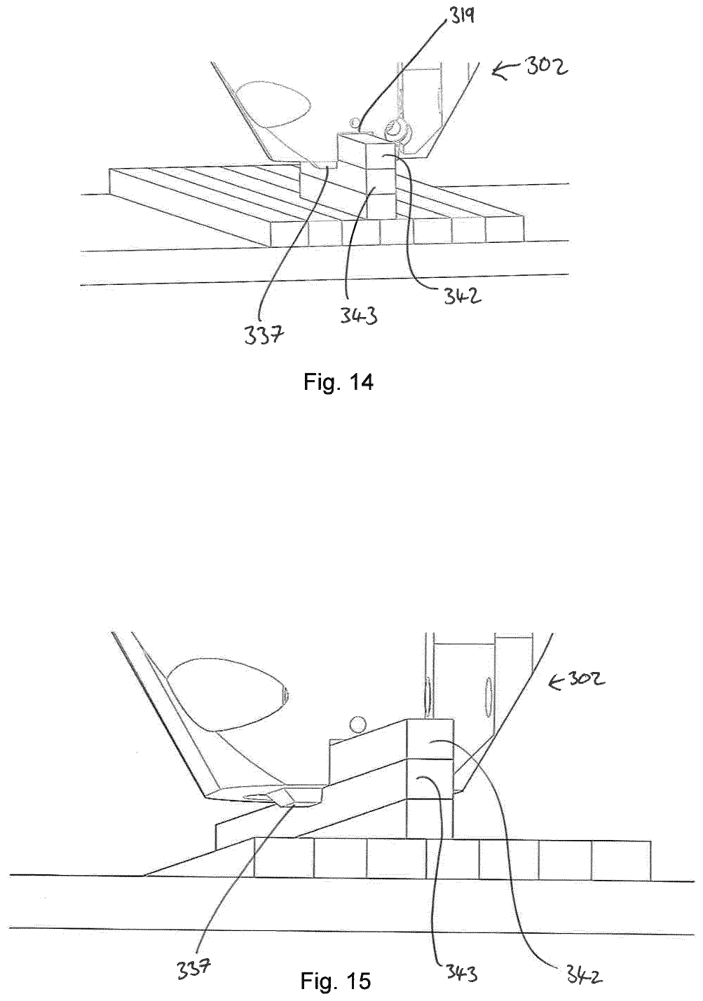

FIG. 14 shows the fourth extruder head being used;

FIG. 15 shows another view of the fourth extruder head being used;

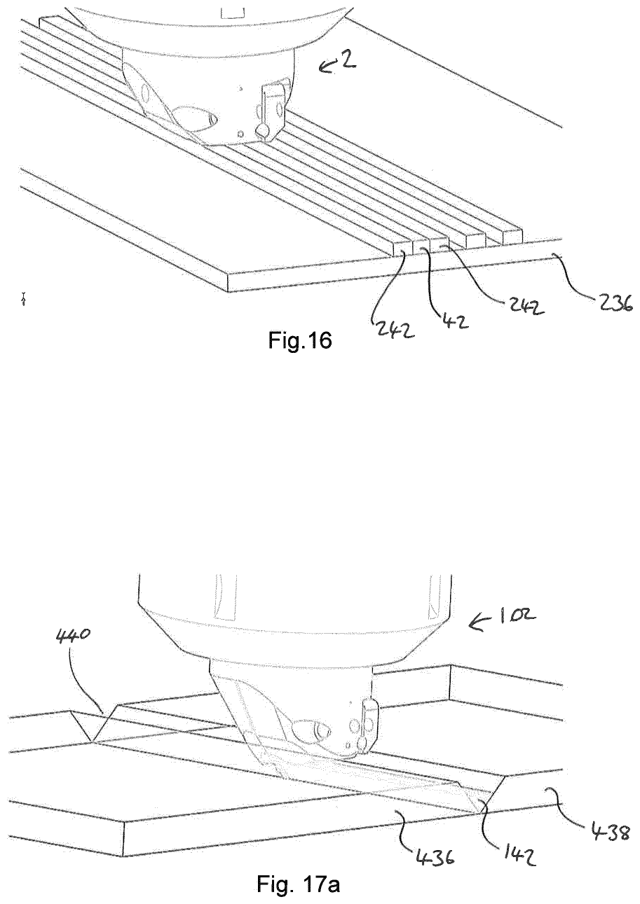

FIG. 16 shows the tool being used for plate deposition;

FIG. 17a shows the tool being used for the first stage of a multi-pass join;

FIG. 17b shows the extruder head for the first stage of a multi-pass join in partial cross-section;

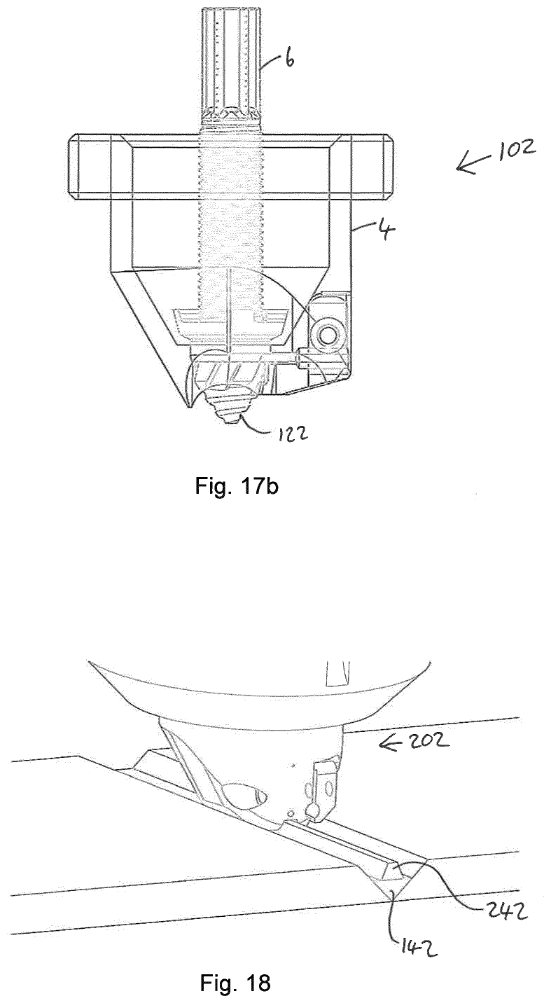

FIG. 18 shows the tool being used for the second stage of a multi-pass join;

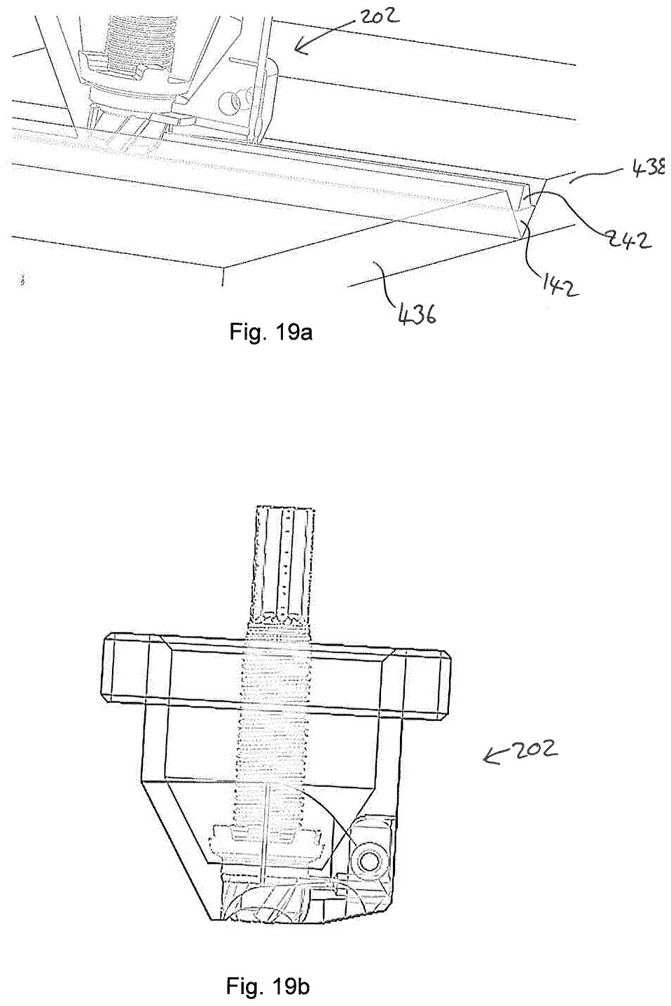

FIG. 19a shows in partial cross section the tool being used for the second stage of a multi-pass join;

FIG. 19b shows the extruder head for the second stage of a multi-pass join in partial cross-section;

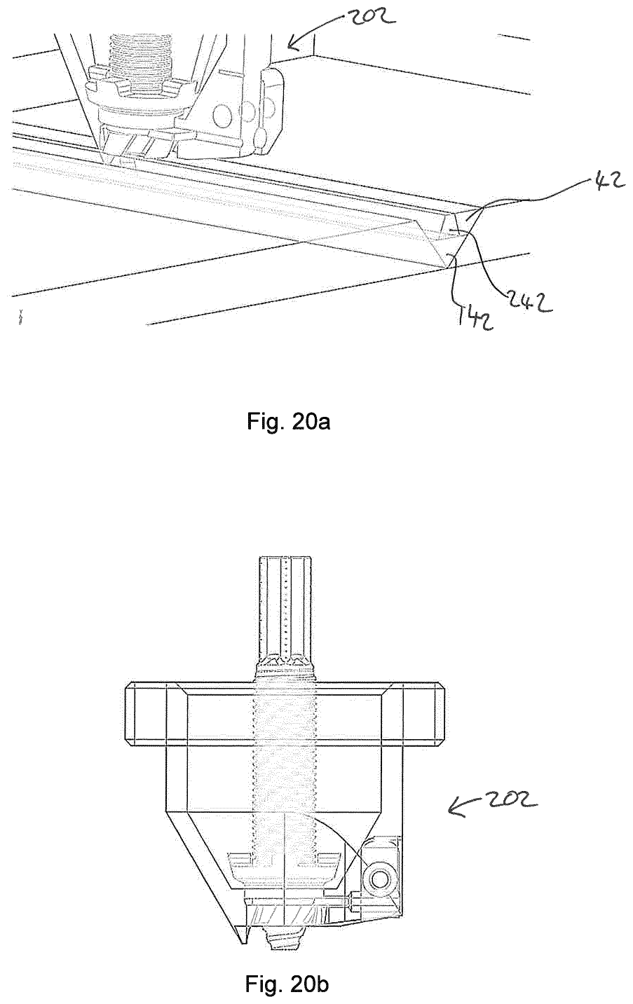

FIG. 20a shows the tool being used for the third stage of a multi-pass join;

FIG. 20b shows the extruder head for the third stage of a multi-pass join in partial cross-section;

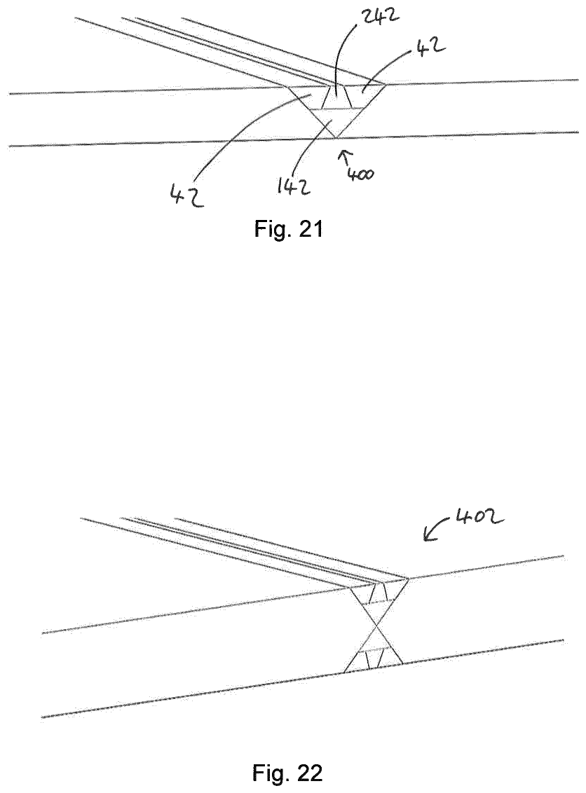

FIG. 21 shows a completed multi-pass join; and

FIG. 22 shows a double sided multi-pass join.

FIG. 1 shows an extrusion and bonding tool 1 for carrying out a solid-state hybrid metal extrusion and bonding process, the tool being for extruding a metal extrusion material and bonding the extrusion material to a metal substrate. The tool comprises an extrusion head 2 which attaches to and is driven by a drive mechanism 3.

As shown in FIGS. 2a and 2b, the extruder head 2 comprises a stationary extruder housing 4 which circumferentially surrounds a rotatable spindle 6. The spindle 6 and extrusion housing 4 together form an extrusion chamber 8 which extends around the spindle 6.

The spindle 6 and housing 4 may both be formed of steel.

The extrusion chamber 8 has three walls formed by a groove on the rotatable spindle 6 and a stationary wall formed by the extrusion housing 4.

The groove on the rotatable spindle 6 that forms three walls of the extrusion chamber 8 is formed between a larger diameter die section 10 of the spindle and a spindle ring 12. The spindle ring 12 is mounted on the spindle 6 and is provided to facilitate assembly of the tool 1. The spindle ring 12 has a locking surface 14 which allows the spindle 6 to engage with the aforementioned driving mechanism 3.

The die section 10 of the spindle has a plurality of moving dies 16 formed thereon. The moving dies 16 are grooves in the surface of the die section 10 of the spindle 6 which connect the extrusion chamber 8 to the environment outside the extrusion head 2.

The extrusion housing 4 comprises a die 18 which is a stationary die which is also in communication with the extrusion chamber 8.

Located in the extrusion chamber 8 is an abutment 20. The abutment 20 blocks the extrusion chamber 8. In use, the abutment 20 causes extrusion material in the extrusion chamber 8 to be forced out of the dies 16 and 18.

The spindle 6 has a deformation portion 22 that in use contacts and plastically deforms the substrate on which the extrudate will be deposited.

The moving dies 16 and the deformation portion 22 are arranged so that when extrusion material is extruded through the dies 16 the extrudate is guided to towards the rotation axis of the spindle.

The extruder head 2 also comprises a sealing protrusion 24. In use this sealing protrusion 24 seals against the substrate to prevent leakage of extrudate in front of the tool.

The rotatable spindle 6 is rotated and extrusion material is fed into the extrusion chamber 8. The extrusion material is pulled through the extrusion chamber 8 by friction from its entrance point towards the abutment 20. When the extrusion material reaches the abutment 20 the pressure in the extrusion chamber 8 rises and extrusion material is forced out of the extrusion chamber 8 through the stationary die 18 in the extruder housing 4 and the moving dies 16 in the spindle 6.

In use the deformation portion 22 of the spindle is in contact with the substrate (not shown in FIG. 1 or 2a, b). This plastically deforms the substrate immediately before the extruded extrusion material is deposited on the substrate.

In use the tool is moved in direction x to create a strip of extrusion material which bonds to the underlying deformed substrate.

FIG. 2a shows the separate component parts of the extruder head 2 (including the housing 4 being shown twice from different perspectives). The view of the housing 4 at the top of the figure shows the underside of the housing 4 and in particular shows a sealing surface 34 (which is shaded grey for clarity). In use this sealing surface 34 is in contact with the top surface of the substrate (or substrates in the case that two substrates are being joined together) and seals thereto. The extrusion material is extruded out of the stationary die 18 through the seal surface 34.

The extruder head 2 shown in FIGS. 1 and 2a, b is specially designed for butt joining two plates together.

FIG. 4 shows a schematic of the tip of the spindle 6. The arrow at the top of the figure shows the rotation direction of the spindle 6. This schematic shows the direction in which extrusion material enters the extrusion chamber by arrow 26. The extrusion material is pulled around the spindle 6 and is forced out of the extrusion chamber either at the stationary die 18 in the housing 4 and guided in a direction illustrated by arrow 28 or at one of the moving dies 16 in the spindle 6 and guided in a direction illustrated by arrow 30.

As shown in FIG. 3, the housing 4 may have a slot 32 therethrough. Whilst the extruder housing 4 and spindle 6 may mate together to form the extrusion chamber 8, due to the high forces involved there may be leakage of extrusion material through the seal between the stationary housing 4 and the rotating spindle 6. In view of this, the housing 4 may be provided with a slot 32 therethrough. The slot 32 permits the removal of extrusion material flash formed when such leakage occurs. The slot 32 is shaped to permit a machining tool to be inserted which can remove the extrusion material flash. Such a slot 32 allows the extrusion material leakage problem to be solved without significantly affecting the mechanical integrity of the extruder housing 4.

The tool 1 is specially designed to minimise forces on the spindle.

Shear fracture in a rotating spindle will occur when the maximum shear force r during operation exceeds the shear strength T₀ of the material of the spindle:

$$τ > {τ}_{0} = \frac{2}{π} \frac{{M}_{t}}{{r}^{3}}$$

from which the maximum allowable torque Mₜ can be calculated:

$${M}_{τ} < {τ}_{0} \frac{π}{2} {r}^{3}$$

Thus, if the spindle is made of steel with a shear strength of 850 MPa and has a radius of 5 mm the maximum allowable torque will be 167 Nm.

To minimise the forces the tool may comprise low friction coatings on the surfaces of the spindle 6 and the extruder housing 4 which contact each other when the tool is assembled and in use. These coatings may be for the purpose of reducing friction between these two parts 4 and 6 which move relative to each other.

The tool 1 may also comprise a coating on the surfaces of the tool that contact the substrate during use. This may comprise parts of the tool, such as the extrusion housing 4 and sealing protrusion 24, which seal against the substrate when the extrusion and bonding is occurring.

The abutment 20 which guides extrusion material out of the extrusion chamber 8 may comprise a coating on the surface which in use contacts the extrusion material.

The coating may be a dual coating with a high wear resistance underlayer, and a low friction coating surface layer.

The high wear resistance layer may be an AlTiN type coating. The low friction coating may be a diamond-like carbon coating, e.g. a W-DLC type coating.

The extrusion chamber 8, or at least the moving walls of the extrusion chamber 8 may be uncoated, or at least not comprise a low friction coating. This is to ensure that there is sufficient sticking friction between the extrusion material and the extrusion chamber 8 to obtain a high enough drag force on the incoming extrusion material to allow the extrusion to occur.

FIG. 5 shows the extruder head 2 for butt joining two plates together in use joining two plates 36 and 38.

As shown most clearly in FIG. 6, the tool is used to join two parallel plates 36 and 38. The plates 36 and 38 are placed in a set up with a gap 40 between the two plates. The deformation portion 22 of the spindle 6 is received in the gap 40 between the two plates 36 and 38 (see FIG. 5). The width of the gap 40 may be smaller than the diameter of the deformation portion 22 of the spindle 6. This is so that when the spindle 6 rotates the deformation portion 22 plastically deforms the two plates 36 and 38.

The seal surface 34 of the extruder housing 4 may contact the upper surface of each of the plates 36 and 38 and seal thereto.

The sealing protrusion 24 may be received in the gap 40 and seal on each side against the two substrates.

To join the two plates 36 and 38 the deformation portion 22 and sealing protrusion 24 are lowered into the gap 40 until the sealing surface 34 contacts and seals against the top surfaces of the two plates 36, 38. The spindle 6 is rotated so as to plastically deform the substrates 36, 38 and extrusion material is fed into the extrusion chamber 8 and forced out through one or more of the dies 16, 18 into the gap 40 which has just been deformed by the spindle 6. The tool 1 is moved in direction x to form a continuous bond 42 along the joint between the two plates 36, 38.

The tool 1 may also, in addition to the aforementioned butt joining, be used for fillet joining (see FIGS. 7 to 9), bead-on plate deformation (see FIGS. 10 to 12), additive layer manufacturing (see FIGS. 13 to 15), surface plating (see FIG. 16) and/or multi-pass joining (see FIGS. 17 to 22).

The tool 1 may have different, interchangeable extruder heads 2, 102, 202 and 302 respectively for butt joining (see FIGS. 1 and 4), fillet joining (see FIGS. 7a and b), bead-on-plate deformation (see FIGS. 10a and b) and additive layer manufacturing (see FIGS. 13a and b). These heads may be used and in certain cases together in sequence to achieve a plurality of different applications.

For each of the extruder heads the like features and components to the butt joining extruder head will generally not be described but rather the description will focus on the main differences and features specially adapted for the particular application the extruder head is designed for.

The fillet joining extruder head 102 is used for joining two plates 136 and 138 which extend at an angle to each other about a join 140. The spindle 6 of the fillet joining extruder head 102 comprises a tapered/conical deformation portion 122 which is designed to contact and deform both the plates 136, 138 near the join 140.

The bottom of the extruder housing 4 has a first sealing surface 134a which in use seals against one of the plates 138 and a second sealing surface 134b which in use seals against the other of the plates 136. The angle between the surfaces of the first and second sealing surfaces 134a and 134b may be substantially the same as the angle between the two plates 136 and 138.

Instead of a sealing protrusion 24 the extruder head 102 comprises a nose 124 which is designed to seal against the two plates 136 and 138 in front of the deformation portion 122 of the spindle 6.

To join the two plates 136 and 138 the deformation portion 122 and sealing nose 124 are inserted in the crevice/gap 140 between the two plates 136 and 138 until the sealing surfaces 134a and 134b contact and seal against the surfaces of the two plates 136, 138 about the crevice 140. The spindle 6 is rotated so as to plastically deform the substrates 136, 138 about the join 140 and extrusion material is fed into the extrusion chamber 8 and forced out through one or more of the dies 16, 18 into the crevice 140 which has just been deformed by the spindle 6. The tool 1 is moved in direction x to form a continuous fillet bond 142 along the join 140 between the two plates 136, 138.

The bead-on-plate extruder head 202 is used for joining an extruded bead of material onto the surface of a plate 236. The spindle 6 of the bead-on-plate extruder head 202 comprises a flat deformation portion 222 which is designed to contact and deform the surface of the plates 23 on which the extrudate will be deposited.

The bottom of the extruder housing 4 has a sealing surface 234 which in use seals against the surface of the plate 236. The sealing surface 234 extends around the front of the spindle 6.

The spindle 6 does not comprise any moving dies and the bottom wall of the extrusion chamber 8 is formed instead by a top surface of the deformation portion 222 of the spindle 6.

The stationary die 18 in the extrusion housing 4 opens into a channel 219 which directs the extrudate in a rearward direction away from the spindle 6 and in a direction parallel to the surface of the plate 236 to form a bead 242 on the plate.

The bottom surface of the housing 4 comprises a recess 235 which allows beads 242 to be deposited close together as shown in FIG. 11.

To deposit and bond the bead 242 on the plate 236 the deformation portion 222 and sealing surface 234 are put in contact with the surface of the plate 236. The spindle 6 is rotated so as to plastically deform the plate 236 underneath the deformation portion 222 in location where a bead of extrudate is about to be deposited. Extrusion material is fed into the extrusion chamber 8 and forced out through the die 18 and guided onto the deformed surface in a continuous bead by the channel 219 such that the extrudate bonds to the plate 236 in a bead 242. The tool 1 is moved in direction x to form a continuous bead 242 on the surface of the plate 236. This process may be repeated a number of times to form a plurality of beads 242 on the surface of the plate 236. The recess 235 can be used to form the beads a set distance apart. This can be achieved by accommodating a bead 242 which has already been formed on the plate 236 in the recess 235. As a result, each bead 242 will be separated by a distance equal to the distance between the recess 235 and channel 219 on the extruder head 202.

As shown for example in FIG. 16, the tool 1 can be used to form a layer on a plate 236. This can be achieved by forming a plurality of beads 242 on the plate 236 as shown in FIG. 12 using the bead-on-plate extruder head 202 and then forming a butt joint 42 between two adjacent beads 242 using a butt joining extruder head 2.

The additive layer manufacturing extruder head 302 is used for joining an extruded bead of material onto an already deposited bead of material (a substrate bead) 343. The spindle 6 of the additive layer manufacturing extruder head 302 comprises a flat deformation portion 322 which is designed to contact and deform the surface of the already deposited bead 343 on which the extrudate will be deposited.

The bottom of the extruder housing 4 has a sealing surface 334 which in use seals against the top surface of the already deposited bead 343. The sealing surface 334 extends around the front of the spindle 6.

The spindle 6 does not comprise any moving dies and the bottom wall of the extrusion chamber 8 is formed instead by a top surface of the deformation portion 322 of the spindle 6.

The stationary die 18 in the extrusion housing 4 opens into a channel 319 which directs the extrudate in a rearward direction away from the spindle 6 and in a direction parallel to the surface of the already deposited bead 343 to form a bead 342 on the already deposited bead 343.

The bottom surface of the housing 4 comprises a sealing rim 337 which when the sealing surface 334 is in contact with the surface of the already deposited bead 343 extends down the sides of the bead 343. This is used to guide the tool 1 and ensure that the bead 342 is deposited on top of the previously deposited bead 343.

To deposit and bond the bead 342 on the substrate bead 343 the deformation portion 322 and sealing surface 334 are put in contact with the surface of the substrate bead 343. The spindle 6 is rotated so as to plastically deform the bead 343 underneath the deformation portion 322 where a bead of extrudate is about to be deposited. Extrusion material is fed into the extrusion chamber 8 and forced out through the die 18 and guided onto the deformed bead surface in a continuous bead by the channel 319 such that the extrudate bonds to the substrate bead 343 in a newly deposited bead 342.

The tool 1 is moved to form a continuous bead 342 on the substrate bead 343 which creates a taller bead of material on a component. This process may be repeated a number of times to form a plurality of beads 342 on top of each other.

The tool 1 can be used to form a multi-pass joint 400 between two plates 436 and 438 which have an angled gap 440 therebetween. This may be achieved by (see for example FIGS. 17a and 17b) using a fillet joint extruder head 102 to extrude a first pass of extrudate which is bonded to each of the two plates 436 and 438 in the bottom of the angled gap 440.

Next (as shown in FIGS. 18,19a and 19b) a bead-on-plate extruder head 202 may be used to form a bead 242 on the fillet joint 142 in the gap 440 between the two plates 436 and 438. The bead-on-plate extruder head 202 specially designed for a multi-pass join is shown in FIG. 19a and has angled sides so that it can fit in the gap between the two components 436, 438.

Next a butt joining extruder head 2 (as shown in FIG. 20b) can be used on either side of the deposited bead 242 to form a butt joint 42 between the central bead 242 and one of the plates 438 and a second butt joint 42 between the central bead 242 and the other of the two plates 436 to form a multi pass joint 400 as shown in FIG. 21.

A multi-pass joint may be used to join thick plates which cannot be joined by a single pass.

For even thicker plates a double sided multi-pass joint 402 as shown in FIG. 22 may be formed. In this case, a multi-pass joint 400 is formed on either side of the joint (i.e. on opposite surfaces of the two plates) in the manner described above for a single multi-pass join.

1. An extrusion and bonding tool for carrying out a solid-state hybrid metal extrusion and bonding process, wherein the tool is for extruding a metal extrusion material and bonding the extrusion material to a metal substrate, the tool comprising:
a main body; and
a rotating die through which the extrusion material is extruded,
wherein the rotating die moves relative to the main body of the tool; and
wherein the extrusion material, in use, is extruded through the rotating die at a position that can vary about a circumferential path about a rotation axis of the tool

2. A tool according to claim 1, wherein the tool comprises an extrusion chamber and wherein some extrusion material, when in the extrusion chamber, is in contact with the rotating die from the point at which it enters the extrusion chamber and is forced through the moving die once the extrusion material has moved a certain distance around the extrusion chamber and the pressure in the extrusion chamber has increased above a threshold extrusion pressure.

3. A tool according to claim 1 or 2, the tool comprising a rotatable spindle.

4. A tool according to claim 3, wherein the rotatable spindle is arranged to, in use, contact and deform the substrate.

5. A tool according to claim 3 or 4, wherein the rotating spindle comprises the rotating die.

6. A tool according to any preceding claim, wherein the tool comprises a plurality of dies for the extrusion of the extrusion material.

7. A tool according to any preceding claim, wherein the tool comprises a stationary die.

8. A tool according to any preceding claim, wherein the tool is arranged so that when extrusion material is extruded through the moving die it is directed towards a central axis of the tool.

9. A tool according to any preceding claim, comprising a guide, wherein the guide is arranged so that, in use, extrusion material is guided in a direction different to the direction in which it was extruded.

10. A tool according to claim 9, wherein the tool comprises a plurality of guides and wherein at least two of the guides guide extrudate in a different direction to each other.

11. A tool according to any preceding claim, a wherein the tool comprises an extruder housing that surrounds the rotatable spindle, and wherein the extruder housing together with the spindle form an extrusion chamber.

12. A tool according to claim 11, wherein the extruder housing forms a stationary die.

13. A tool according to claim 10, 11 or 12, wherein the extruder housing comprises a slot that permits the removal of extrusion material flash formed when leakage occurs between the rotatable spindle and the housing.

14. A tool according to any of claims 11 to 13, wherein the tool comprises a coating on the surfaces of the rotatable spindle and the extruder housing that contact each other when the tool is in use and/or comprises a coating on the surfaces of the tool that will contact the substrate during use.

15. A tool according to claim 14, wherein the coating is a dual coating with a high wear resistance underlayer and a low friction surface layer

16. A tool according to any preceding claim, wherein the tool is arranged so that cooling of the extruder housing and/or extrudate can be performed during use.

17. A tool according to any preceding claim, wherein the tool is for joining two substrates together, and wherein the tool is arranged so that, in use, the tip of a spindle is received in a gap between the two substrates and deforms at least part of the surface of at least one of the two substrates that face each other.

18. A tool according to any preceding claim, wherein the tool comprises a plurality of interchangeable extruder heads that are each designed for a different application.

19. A tool according to claim 18, wherein the tool comprises one or more of a butt joining extruder head which is for butt joining two substrates, and a fillet joining extruder head which for fillet joining two substrates.

20. An extrusion and bonding tool for carrying out a hybrid metal extrusion and bonding process, the tool being for extruding a metal extrusion material and bonding the extrusion material to a metal substrate, the tool comprising:
an extrusion chamber; and
a plurality of dies through which the extrusion material is extruded associated with the extrusion chamber,
wherein the tool is arranged so that, in use, the extrusion material is received in the extrusion chamber and plasticised within the extrusion chamber before being extruded through one of the dies onto the substrate.

21. A tool according to claim 20, the tool comprising a rotatable spindle that is arranged to, in use, contact and deform the substrate.

22. A tool according to claim 21, wherein the rotatable spindle comprises a moving die that in use moves relative to a main body of the tool.

23. A tool according to claim 20, 21 or 22, wherein the tool comprises a moving die that in use moves relative to a main body of the tool and wherein the tool is arranged so that when extrusion material is extruded through a moving die it is directed towards a central axis of the tool.

24. A tool according to any of claims 20 to 23, comprising a guide, wherein the guide is arranged so that, in use, extrusion material extruded is guided in a direction different to the direction in which the extrudate was extruded.

25. A tool according to claim 24, wherein the tool comprises a plurality of guides and wherein at least two of the guides guide extrudate in a different direction to each other.

26. A tool according to any of claims 21 to 25, a wherein the tool comprises a rotatable spindle and an extruder housing that surrounds the rotatable spindle, and wherein the extruder housing together with the spindle form an extrusion chamber.

27. A tool according to claim 26, wherein the extruder housing forms a stationary die.

28. A tool according to claim 26 or 27, wherein the extruder housing comprises a slot that permits the removal of extrusion material flash formed when leakage occurs between the rotatable spindle and the housing.

29. A tool according to any of claims 21 to 28, wherein the tool comprises a coating on the surfaces of the rotatable spindle and the extruder housing that contact each other when the tool is in use and/or comprises a coating on the surfaces of the tool that will contact the substrate during use.

30. A tool according to claim 29, wherein the coating is a dual coating with a high wear resistance underlayer and a low friction surface layer

31. A tool according to any of claims 20 to 30, wherein the tool is arranged so that cooling of the tool and/or extrudate can be performed during use.

32. A tool according to any of claims 20 to 31, wherein the tool is for joining two substrates together, and wherein the tool is arranged so that, in use, a tip of a rotatable spindle is received in a gap between the two substrates and contacts and deforms at least part of the surfaces of the two substrates that face each other.

33. A tool according to any of claims 20 to 32, wherein the tool comprises a plurality of interchangeable extruder heads that are each designed for a different application.

34. A tool according to claim 33, wherein the tool comprises one or more of a butt joining extruder head that is for butt joining two substrates, and a fillet joining extruder head which for fillet joining two substrates.

35. A solid-state method of extruding a metal extrusion material and bonding the metal extrusion material to a substrate, the method comprising, using the tool of any preceding claim.

36. A method according to claim 35, the method comprising extruding the extrusion material through a plurality of dies.

37. A method according to claim 35 or 36, the method comprising extruding the extrusion material through a rotating die.
